(19) United States
(12) Patent Application Publication
(10) Pub. No.: US 2025/0229339 A1
(43) Pub. Date: Jul. 17, 2025

(54) LASER IRRADIATION APPARATUS

(71) Applicant: SEIKO EPSON CORPORATION, Tokyo (JP)

(72) Inventors: Yoshitomo KUMAI, OKAYA-SHI (JP); Yoji KITANO, CHINO-SHI (JP)

(73) Assignee: SEIKO EPSON CORPORATION, Tokyo (JP)

(21) Appl. No.: 19/021,243

(22) Filed: Jan. 15, 2025

(30) Foreign Application Priority Data
Jan. 16, 2024 (JP) 2024-004393

(51) Int. Cl. B22F 12/90; B22F 12/41; B22F 12/47; B33Y 30/00; B33Y 50/02; B41J 2/325; B41J 29/00

(52) U.S. Cl. CPC B22F 12/90; B22F 12/41; B22F 12/47; B33Y 30/00; B33Y 50/02; B41J 2/325; B41J 29/00

(57) ABSTRACT

A laser irradiation apparatus includes a control unit, wherein the control unit executes a first process of controlling a laser element and a moving mechanism to irradiate an inspection target object with laser light while the laser element and the inspection target object face each other, a second process of controlling the imaging unit to image the inspection target object being irradiated with the laser light, and a third process of controlling the laser element and the moving mechanism to irradiate an irradiation target object with laser light, based on an imaging result in the second process, while the laser element and the irradiation target object face each other, and at the same time to change a relative position of the laser element and the irradiation target object.

The present application is based on, and claims priority from JP Application Serial Number 2024-004393, filed Jan. 16, 2024, the disclosure of which is hereby incorporated by reference herein in its entirety.

### BACKGROUND

### 1. Technical Field

The present disclosure relates to a laser irradiation apparatus.

### 2. Related Art

There have been known a processing apparatus that processes a processing target object and a recording apparatus that performs recording such as printing on a recording target object through irradiation with laser light.

For example, JP-A-2021-154714 discloses a three-dimensional printer apparatus including a printer head configured to include a light-emitting array in which laser elements are arrayed, a liquid tank that houses a photosetting liquid that is cured with light emitted from the printer head, and a stage unit to which a mold formed through curing with light adheres.

In the laser irradiation apparatus that irradiates laser light as described above, for example, when the laser processing is repeatedly performed, the characteristics of the laser elements are deviated from the designed value. When an irradiation target is irradiated while the characteristics of the laser elements are deviated from the design value, accurate irradiation cannot be performed.

### SUMMARY

A laser irradiation apparatus according to one aspect of the present disclosure includes a laser element configured to emit laser light, a moving mechanism configured to move a relative position of the laser element and an irradiation target object and a relative position of the laser element and an inspection target object, an imaging unit configured to image the inspection target object, and a control unit configured to control the laser element, the moving mechanism, and the imaging unit, wherein the control unit is configured to execute: a first process of controlling the laser element and the moving mechanism to irradiate the inspection target object with laser light while the laser element and the inspection target object face each other, a second process of controlling the imaging unit to image the inspection target object being irradiated with the laser light, and a third process of controlling the laser element and the moving mechanism to irradiate the irradiation target object with laser light, based on an imaging result in the second process, while the laser element and the irradiation target object face each other, and at the same time to change the relative position of the laser element and the irradiation target object.

### BRIEF DESCRIPTION OF THE DRAWINGS

FIG. 1 is a perspective view schematically illustrating a laser irradiation apparatus according to a first embodiment.

FIG. 2 is a perspective view schematically illustrating the laser irradiation apparatus according to the first embodiment.

FIG. 3 is a bottom view schematically illustrating a head of the laser irradiation apparatus according to the first embodiment.

FIG. 4 is a cross-sectional view schematically illustrating the laser irradiation apparatus according to the first embodiment.

FIG. 5 is a flowchart for describing a process of a control unit of the laser irradiation apparatus according to the first embodiment.

FIG. 6 is a plan view and a cross-sectional view that schematically illustrate an inspection target object.

FIG. 7 is a graph for describing a relationship between a current injected to a laser element and a light output.

FIG. 8 is a graph for describing a relationship between a current injected to a laser element and a light output.

FIG. 9 is a plan view and a cross-sectional view that schematically illustrate an inspection target object.

FIG. 10 is a perspective view schematically illustrating a laser irradiation apparatus according to a first modification example of the first embodiment.

FIG. 11 is a bottom view schematically illustrating a head of the laser irradiation apparatus according to the second modification example of the first embodiment.

FIG. 12 is a perspective view schematically illustrating a laser irradiation apparatus according to a second embodiment.

FIG. 13 is a cross-sectional view schematically illustrating the laser irradiation apparatus according to the second embodiment.

FIG. 14 is a flowchart for describing a process of a control unit of the laser irradiation apparatus according to the second embodiment.

FIG. 15 is a perspective view schematically illustrating a head of a laser irradiation apparatus according to a modification example of the second embodiment.

### DESCRIPTION OF EMBODIMENTS

Preferred embodiments of the present disclosure are described in detail below with reference to the drawings. Note that the embodiments described below do not unduly limit the content of the present disclosure described in the claims. In addition, not all the configurations described below are essential constituent elements of the present disclosure.

### 1. First Embodiment

### 1. Laser Irradiation Apparatus

### 1.1.1. Configuration

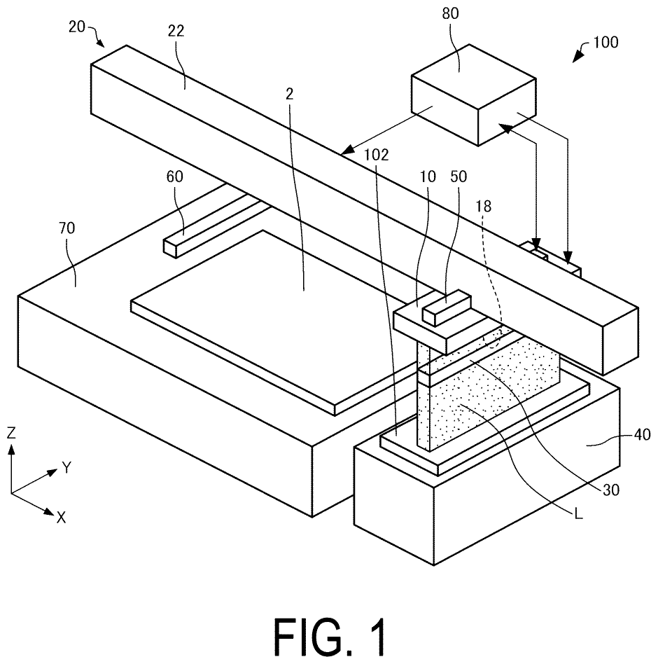

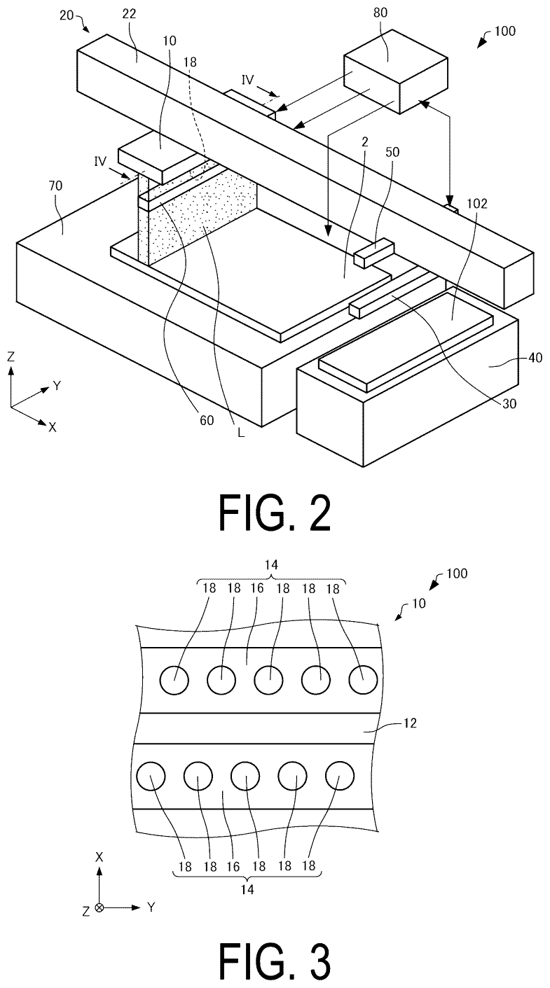

First, a laser irradiation apparatus according to a first embodiment is described with reference to the drawings. FIG. 1 and FIG. 2 are perspective views schematically illustrating a laser irradiation apparatus 100 according to the first embodiment. Note that, in FIG. 1 and FIG. 2, an X axis, a Y axis, and a Z axis are illustrated as three axes orthogonal to one another. For example, the X-axis direction and the Y-axis direction are horizontal directions. For example, the Z-axis direction is a vertical direction.

As illustrated in FIG. 1 and FIG. 2, for example, the laser irradiation apparatus 100 includes a head 10, a movement mechanism 20, a first optical element 30, a first support unit 40, an imaging unit 50, a second optical element 60, a second support unit 70, and a control unit 80. For example, the laser irradiation apparatus 100 is a laser processing apparatus. For example, the laser irradiation apparatus 100 is a metal 3D printer that uses the selective laser melting (SLM) method.

The head 10 is supported on a rail 22 of the movement mechanism 20. The head 10 emits laser light L. In the example illustrated in the drawing, the head 10 emits the laser light L in the −Z-axis direction. The head 10 processes an irradiation target object 2 with the laser light L. Here, FIG. 3 is a bottom view schematically illustrating the head 10.

As illustrated in FIG. 3, for example, the head 10 includes a first substrate 12 and a laser element array 14. The first substrate 12 supports the laser element array 14. The material of the first substrate 12 is not particularly limited, and is metal such as aluminum, iron, and copper.

The laser element array 14 is provided to the first substrate 12. In the example illustrated in the drawing, the laser element array 14 has a shape extending in the Y-axis direction. For example, a plurality of the laser element arrays 14 are provided. The number of the laser element arrays 14 is not particularly limited. In the example illustrated in the drawing, two laser element arrays 14 are provided. The two laser element arrays 14 are arrayed in the X-axis direction.

For example, the laser element array 14 includes a second substrate 16 and a laser element 18. The second substrate 16 is provided to the first substrate 12. The material of the second substrate 16 is not particularly limited, and may be, for example, aluminum oxide, aluminum nitride, ceramic, or the like.

The laser element 18 is provided to the second substrate 16. The laser element 18 is supported on the rail 22 via the first substrate 12 and the second substrate 16. The laser element 18 emits the laser light L. In the example illustrated in the drawing, the laser element 18 has a circular shape. For example, the laser element 18 is a photonic crystal surface emitting laser (PCSEL) using a photonic crystal effect. The laser light L emitted from the laser element 18 being a PCSEL has a small radiation angle and a high light output.

A plurality of the laser elements 18 are provided in one laser element array 14. In the example illustrated in the drawing, the plurality of laser elements 18 are arrayed in the Y-axis direction in one laser element array 14. In the laser element arrays 14 adjacent to each other in the X-axis direction, the laser elements 18 are displaced in the Y-axis direction. In other words, in the laser element arrays 14 adjacent to each other in the X-axis direction, the center of the laser element 18 in one laser element array 14 and the center of the laser element 18 in the other laser element array 14 do not overlap with each other as viewed from the X-axis direction. In this manner, an irradiation area with the laser light L emitted from the head 10 can be increased.

For example, the movement mechanism 20 includes the rail 22 and a motor, which is omitted in illustration. As illustrated in FIG. 1 and FIG. 2, the rail 22 supports the head 10. The movement mechanism 20 changes a relative position of the head 10 and the irradiation target object 2 and a relative position of the head 10 and an inspection target object 102 by the motor, which is omitted in illustration. In other words, the movement mechanism 20 changes a relative position of the laser element 18 and the irradiation target object 2 and a relative position of the laser element 18 and the inspection target object 102. For example, the movement mechanism 20 moves the head 10 relatively to the irradiation target object 2 and the inspection target object 102 by the motor, which is omitted in illustration. In other words, the movement mechanism 20 moves the laser element 18 relatively to the irradiation target object 2 and the inspection target object 102. The motor is controlled by the control unit 80. In the example illustrated in the drawing, the movement mechanism 20 moves the head 10 along the X-axis direction. For example, the rail 22 has a shape extending in the X-axis direction. The movement mechanism 20 moves the head 10 along the rail 22. The movement mechanism 20 may further include an encoder, which is omitted in illustration. The movement mechanism 20 does not move the irradiation target object 2 and the inspection target object 102.

The movement mechanism 20 moves the head 10 to achieve a state in which the laser element 18 and the inspection target object 102 face each other as illustrated in FIG. 1. In the example illustrated in the drawing, the laser element 18 faces the inspection target object 102 via the first optical element 30. Further, the movement mechanism 20 moves the head 10 to achieve a state in which the laser element 18 and the irradiation target object 2 face each other as illustrated in FIG. 2. In the example illustrated in the drawing, the laser element 18 faces the irradiation target object 2 via the second optical element 60. In this manner, the movement mechanism 20 can perform switching between a state in which the laser element 18 and the inspection target object 102 face each other and a state in which the laser element 18 and the irradiation target object 2 face each other.

As illustrated in FIG. 1, the laser light L emitted from the laser element 18 enters the first optical element 30. The first optical element 30 is provided between the head 10 and the first support unit 40. The first optical element 30 is provided between the laser element 18 and the inspection target object 102. Although not illustrated, the first optical element 30 may be supported on the rail 22. For example, the first optical element 30 is a lens array. For example, a plurality of lenses configuring the first optical element 30 are provided in accordance with the number of the laser elements 18.

For example, the first support unit 40 is provided in the −Z-axis direction with respect to the first optical element 30. The first support unit 40 supports the inspection target object 102. The first support unit 40 may be a stage that supports the inspection target object 102. The laser light L from the laser element 18 enters the inspection target object 102 in a calibration process.

As illustrated in FIG. 1 and FIG. 2, for example, the imaging unit 50 is supported on the rail 22 of the movement mechanism 20. In the example illustrated in the drawing, the imaging unit 50 is fixed to the rail 22. The imaging unit 50 faces the inspection target object 102. The imaging unit 50 is positioned above the inspection target object 102. In the example illustrated in FIG. 1, the head 10 is positioned between the inspection target object 102 and the imaging unit 50. The inspection target object 102 images the inspection target object 102. For example, the imaging unit 50 is a charge coupled device (CCD) image sensor, a complementary metal oxide semiconductor (CMOS) image sensor, a camera, or the like.

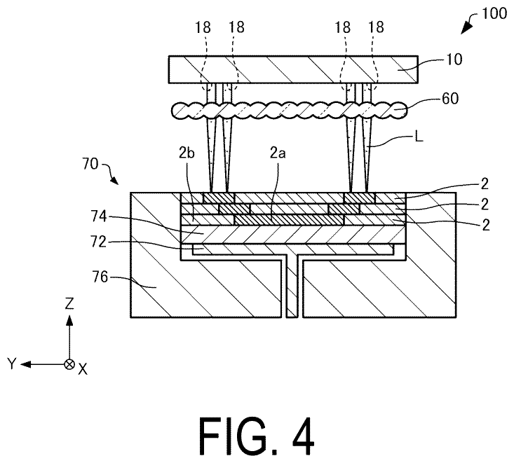

Herein, FIG. 4 is a cross-sectional view taken along the line IV-IV of FIG. 2 schematically illustrating the laser irradiation apparatus 100. Note that, for the sake of convenience, the movement mechanism 20 is omitted in FIG. 4.

As illustrated in FIG. 2 and FIG. 4, the laser light L emitted from the laser element 18 enters the second optical element 60. The second optical element 60 is provided between the head 10 and the second support unit 70. The second optical element 60 is provided between the laser element 18 and the irradiation target object 2. Although not illustrated, the second optical element 60 may be supported on the rail 22. For example, the second optical element 60 is a lens array. The focal point of the lens configuring the second optical element 60 may be located on the irradiation target object 2. In this manner, an irradiation time of the irradiation target object 2 can be reduced. For example, a plurality of the lenses configuring the second optical element 60 are provided in accordance with the number of the laser elements 18.

For example, the second support unit 70 is provided in the −Z-axis direction with respect to the second optical element 60. In the example illustrated in the drawing, the first support unit 40 and the second support unit 70 are arrayed in the X-axis direction. The second support unit 70 is positioned in the −X-axis direction with respect to the first support unit 40. The second support unit 70 supports the irradiation target object 2. The second support unit 70 may be a stage that supports the irradiation target object 2. The laser light L from the laser element 18 enters the irradiation target object 2 in a processing process. For example, the irradiation target object 2 is a process target object to be processed with the laser light L from the laser element 18. For example, the irradiation target object 2 is metal powder that can be melted with the laser light L. The irradiation target object 2 is supplied by a supplying machine, which is omitted in illustration. For example, the materials of the irradiation target object 2 and the inspection target object 102 are the same. Note that the materials of the irradiation target object 2 and the inspection target object 102 may be different from each other.

As illustrated in FIG. 4, for example, the second support unit 70 includes a stage base 72, an elevator mechanism 74, and a housing 76 that accommodates the stage base 72 and the elevator mechanism 74.

The irradiation target object 2 is supplied on the stage base 72. The head 10 irradiates the irradiation target object 2 on the stage base 72 with the laser light L to form a molten portion 2a and a non-molten portion 2b in the irradiation target object 2. After molten through irradiation with the laser light L, the molten portion 2a is cooled and solidified. The non-molten portion 2b is not irradiated with the laser light L. Therefore, the non-molten portion 2b is not solidified and remains as metal powder.

The elevator mechanism 74 supports the stage base 72. In the example illustrated in the drawing, the elevator mechanism 74 moves the stage base 72 along the −Z-axis direction. As the stage base 72 moves, the irradiation target object 2 moves. After the stage base 72 moves along the −Z-axis direction, the supplying machine again supplies the irradiation target object 2 of the second layer. The irradiation target object 2 of the second layer is supplied on the irradiation target object 2 of the first layer. Then, the head 10 irradiates the irradiation target object 2 of the second layer with the laser light L.

As described above, a laminate body composed of a plurality of layers of the irradiation target object 2 can be formed by repeating the series of steps of the supply of the irradiation target object 2 by the supplying machine, the irradiation with the laser light L by the head 10, and the movement of the stage base 72 by the elevator mechanism 74. Further, the non-molten portion 2b in the lamination body is removed by a removal apparatus, which is omitted in illustration. With this, a three-dimensional object having a predetermined shape is shaped. Examples of the removal apparatus include an air blow and a brush.

For example, the control unit 80 is configured by a computer including a processor, a main storage device, and an input/output interface that inputs and outputs a signal with external parts. For example, the control unit 80 implements various functions with the processor executing a program read in the main storage device, for example. Specifically, the control unit 80 controls the laser element 18, the movement mechanism 20, the imaging unit 50, and the elevator mechanism 74. Note that the control unit 80 may be configured by a combination of a plurality of circuits instead of a computer.

### 1.1.2. Operation

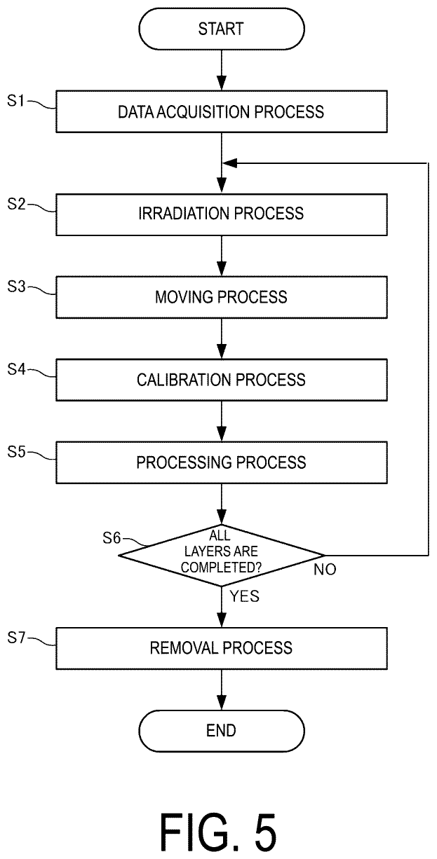

Next, an operation of the laser irradiation apparatus 100 according to the first embodiment is described with reference to the drawings. Specifically, a process of the control unit 80 of the laser irradiation apparatus 100 according to the first embodiment is described with reference to the drawings. FIG. 5 is a flowchart for describing a process of the control unit 80.

For example, a user operates an operation unit, which is omitted in illustration, to output a process start signal for starting a process to the control unit 80. For example, the operation unit is configured by a mouse, a keyboard, a touch panel, or the like. When the control unit 80 receives the process start signal, it starts the process.

First, as illustrated in FIG. 5, the control unit 80 executes a data acquisition process that acquires shaping data for shaping a three-dimensional object (Step S1).

For example, the shaping data includes information relating to the material of the metal powder forming the irradiation target object 2, the number of layers of the irradiation target object 2, the movement speed of the head 10, on/off of the plurality of laser elements 18, and the like.

For example, the shaping data is created by reading shaping data into slicer software installed in a computer coupled to the laser irradiation apparatus 100. The shaping data is data representing an intended shape of a three-dimensional object created by using three-dimensional computer aided design (CAD) software, three-dimensional computer graphics (CG) software and/or the like. For example, as the shaping data, data of the standard triangulated language (STL) format and/or the additive manufacturing file format (AMF) is used. The slicer software divides the intended shape of the three-dimensional object into layers with a predetermined thickness and creates the shaping data for each layer. The shaping data is represented by G codes, M codes, and the like. The control unit 80 acquires the shaping data from a computer coupled to the laser irradiation apparatus 100 or a recording medium such as a universal serial bus (USB) memory.

Subsequently, the control unit 80 controls the laser element 18 and the movement mechanism 20 to execute an irradiation process of irradiating the inspection target object 102 with the laser light L while the laser element 18 and the inspection target object 102 face each other as illustrated in FIG. 1 (Step S2).

Specifically, the control unit 80 causes the movement mechanism 20 to move the laser element 18, and thus the laser element 18 and the inspection target object 102 face each other. Subsequently, the control unit 80 causes the laser element 18 to emit the laser light L. The laser light L from the laser element 18 is emitted to the inspection target object 102 via the first optical element 30.

Subsequently, the control unit 80 controls the movement mechanism 20 to execute a moving process of moving the laser element 18 and the irradiation target object 2 relatively as illustrated in FIG. 2 so that the laser element 18 and the irradiation target object 2 face each other (Step S3).

Specifically, the control unit 80 causes the movement mechanism 20 to move the laser element 18 along the −X-axis direction so that the laser element 18 and the irradiation target object 2 face each other. In the moving process, the control unit 80 does not cause the laser element 18 to emit the laser light L.

Subsequently, the control unit 80 controls the imaging unit 50 to execute the calibration process of imaging the inspection target object 102 irradiated with the laser light L (Step S4). In the calibration process, for example, the control unit 80 determines an injection current to the laser element 18 in the processing process, based on the imaging result of the imaging unit 50.

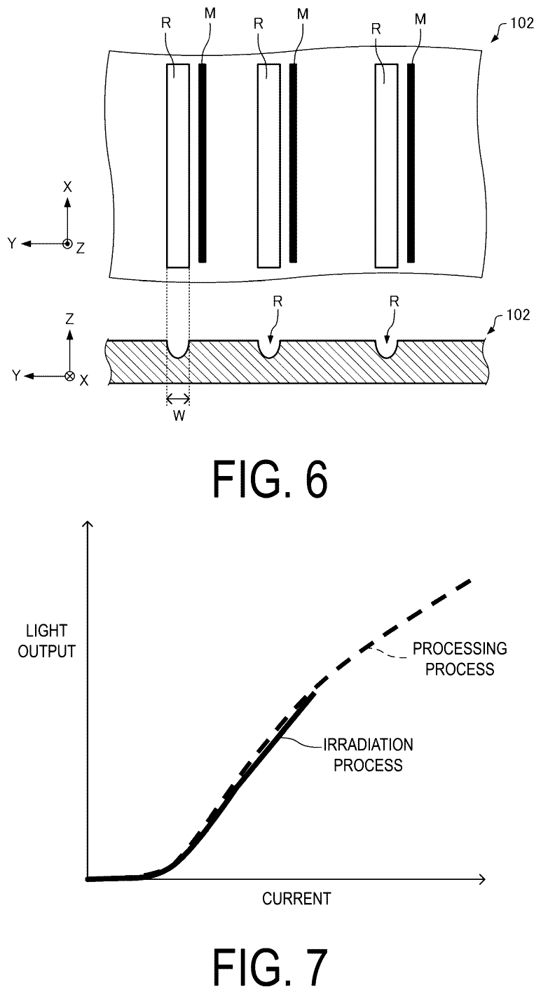

Herein, FIG. 6 is a plan view and a cross-sectional view that schematically illustrate the inspection target object 102. FIG. 6 illustrates the inspection target object 102 after irradiation with the laser light L. As illustrated in FIG. 6, the inspection target object 102 is provided with an alignment mark M.

For example, when a linewidth R of an irradiation trace R irradiated with the laser light L in the image acquired by the imaging unit 50 is smaller than a predetermined value, the control unit 80 determines to increase an injection current to the laser element 18 in the processing process to a value more than an injection current to the laser element 18 in the irradiation process in Step S2. In contrast, when the linewidth W is more than the predetermined value, the control unit 80 determines to reduce an injection current to the laser element 18 in the processing process to a value less than an injection current to the laser element 18 in the irradiation process in Step S2. The predetermined value may be stored in a storage unit, which is omitted in illustration.

Further, in the calibration process, for example, the control unit 80 may determine the laser element 18 to be driven in the processing process, based on the imaging result of the imaging unit 50. As illustrated in FIG. 6, for example, the irradiation trace R is in the +Y-axis direction with respect to the alignment mark M in the image acquired by the imaging unit 50. In such a case, in the processing process, the control unit 80 drives the laser element 18 in the −Y-axis direction with respect to the laser element 18 driven in the irradiation process.

In this manner, the control unit 80 feeds back the imaging result of the imaging unit 50 to the processing process. The calibration process is a process of calibrating a light output of the laser light L in the processing process or the like.

Subsequently, the control unit 80 executes the processing process of controlling the laser element 18 and the movement mechanism 20 to irradiate the irradiation target object 2 with the laser light L, based on the imaging result in the calibration process in Step S4 while the laser element 18 and the irradiation target object 2 face each other, and at the same time to change the relative position of the laser element 18 and the irradiation target object 2 (Step S5).

Specifically, the control unit 80 causes the laser element 18 to emit the laser light L, based on the imaging result of the imaging unit 50 and the shaping data, while the laser element 18 and the irradiation target object 2 face each other. At the same time, the control unit 80 drives the motor of the movement mechanism 20 to move the laser element 18 along the +X-axis direction. In this manner, the irradiation target object 2 can be processed. As illustrated in FIG. 4, the molten portion 2a and the non-molten portion 2b are formed in the irradiation target object 2.

Subsequently, as illustrated in FIG. 5, the control unit 80 executes a determination process of determining whether formation of all the layers of the irradiation target object 2 is completed, based on the shaping data (Step S6).

When it is determined that formation of all the layers of the irradiation target object 2 is not completed (“NO” in Step S6), the control unit 80 returns the process to Step S2. The control unit 80 repeats Steps S2 to S6 until it is determined that formation of all the layers of the irradiation target object 2 is completed in Step S6.

Note that the control unit 80 may return the process to Step S5. Further, the control unit 80 may repeat Steps S5 and S6 until it is determined that formation of all the layers of the irradiation target object 2 is completed in Step S6.

In contrast, when the control unit 80 determines that formation of all the layers of the irradiation target object 2 is completed (“YES” in Step S6), the control unit 80 executes a non-molten portion removal process of causing the removal apparatus to remove the non-molten portion 2b in the lamination body composed of the irradiation target object 2 (Step S7). In this manner, a three-dimensional object is shaped. Further, the control unit 80 terminates the process.

Note that a user may manually remove the non-molten portion 2b. In this case, after determining that formation of all the layers of the irradiation target object 2 is completed, the control unit 80 terminates the process.

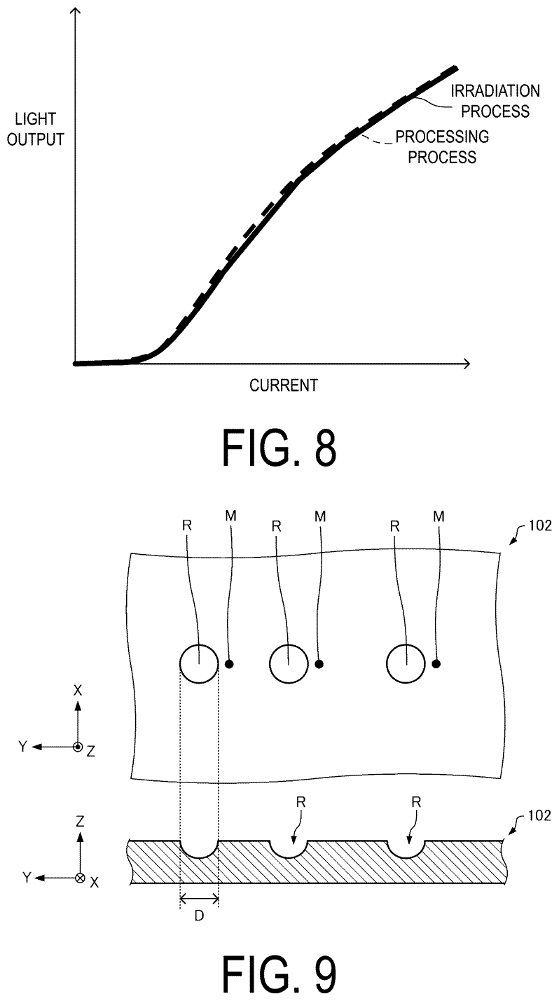

Herein, FIG. 7 and FIG. 8 are graphs for describing a relationship between a current injected to the laser element and a light output. When a photodetector is irradiated with the laser light in the irradiation process for calibration, an injection current cannot be increased as illustrated in FIG. 7, in order to prevent damage to the photodetector. An injection current in the irradiation process for calibration is smaller than an injection current in the processing process.

In contrast, in the laser irradiation apparatus 100, for calibration of the laser element 18, the laser light L enters the inspection target object 102, instead of the photodetector. Thus, the photodetector is not damaged by the laser light L, and an injection current in the irradiation process for calibration can be close to an injection current in the processing process as illustrated in FIG. 8. For example, in the laser irradiation apparatus 100, the laser light L can be emitted from the laser element 18 under the same conditions both in the irradiation process for calibration and the processing process.

Note that, in FIG. 6, the alignment mark M is a line. The alignment mark M may be a dot as illustrated in FIG. 9. The irradiation trace R marked by the laser light L may be in a dot-like shape. In this case, the control unit 80 determines an injection current to the laser element 18 in the processing process, based on a dot diameter D of the irradiation trace R.

### 1.1.3. Actions and Effects

There are provided the laser element 18 that emits the laser light L, the movement mechanism 20 that changes the relative position of the laser element 18 and the irradiation target object 2 and the relative position of the laser element 18 and the inspection target object 102, the imaging unit 50 that images the inspection target object 102, and the control unit 80 that controls the laser element 18, the movement mechanism 20, and the imaging unit 50. The control unit 80 executes the irradiation process being a first process of controlling the laser element 18 and the movement mechanism 20 to irradiate the inspection target object 102 with the laser light L while the laser element 18 and the inspection target object 102 face each other, the calibration process being a second process of controlling the imaging unit 50 to image the inspection target object 102 irradiated with the laser light L, and the processing process being a third process of controlling the laser element 18 and the movement mechanism 20 to irradiate the irradiation target object 2 with the laser light L, based on the imaging result in the calibration process, while the laser element 18 and the irradiation target object 2 face each other, and at the same time to change the relative position of the laser element 18 and the irradiation target object 2.

Thus, in the laser irradiation apparatus 100, even when the characteristics of the laser element 18 are deviated from the design value, the deviation can be detected in the calibration process and fed back to the processing process. In this manner, the irradiation target object 2 can be irradiated accurately in the processing process. For example, when the plurality of laser elements 18 are provided, irradiation can be performed uniformly by the plurality of laser elements 18.

Further, in the laser irradiation apparatus 100, the inspection target object 102 is irradiated with the laser light L while the laser element 18 and the inspection target object 102 face each other. Thus, for example, as compared to a case in which the inspection target object 102 is irradiated with the laser light L while a light path of the laser light L from the laser element to the irradiation target object 2 is changed by a light path changing element such as a mirror and a beam splitter, damage to the light path changing element by the laser light L can be prevented. When the light path changing element is damaged, the laser light L cannot be guided to the inspection target object 102 in some cases. In particular, in the case where the laser element is a PCSEL, when the light path changing element is used, the light path changing element is easily damaged. This is because the radiation angle is narrow.

Further, in the laser irradiation apparatus 100, the irradiation target object 2 is irradiated with the laser light L in the processing process, based on the imaging result of the imaging unit 50. Thus, in the laser irradiation apparatus 100, there is no need to use the photodetector for calibration of the laser element 18, and damage of the photodetector can be prevented. Therefore, the laser light L can be emitted from the laser element 18 under the same conditions both in the irradiation process for calibration and the processing process. Thus, highly accurate calibration can be performed.

In the laser irradiation apparatus 100, the laser element 18 and the imaging unit 50 are supported on the movement mechanism 20. Thus, in the laser irradiation apparatus 100, the apparatus can be simplified as compared to a case in which a support member for supporting the imaging unit is additionally provided, for example.

The laser irradiation apparatus 100 includes the first support unit 40 that supports the inspection target object 102 and the second support unit 70 that supports the irradiation target object 2. The movement mechanism 20 moves the laser element 18 relatively in the X-axis direction being a first direction, and the first support unit 40 and the second support unit 70 are arrayed in the X-axis direction. Thus, in the laser irradiation apparatus 100, the moving direction of the laser element 18 in the processing process and the moving direction of the laser element 18 for achieving a state in which the laser element 18 and the irradiation target object 2 face each other from a state in which the laser element 18 and the inspection target object 102 face each other can be the same X-axis direction. In this manner, the apparatus can be simplified.

In the laser irradiation apparatus 100, the materials of the irradiation target object 2 and the inspection target object 102 are the same. Thus, in the laser irradiation apparatus 100, for example, a difference in the linewidth W of the laser light L between the irradiation process for calibration and the processing process can be reduced.

In the laser irradiation apparatus 100, the irradiation target object 2 is a process target object to be processed with the laser light L from the laser element 18. Thus, in the laser irradiation apparatus 100, the irradiation target object 2 can be processed accurately.

In the laser irradiation apparatus 100, the laser element 18 is a PCSEL. Thus, in the laser irradiation apparatus 100 the radiation angle of the laser light L from the laser element 18 can be narrowed. In this manner, an irradiation time of the irradiation target object 2 can be reduced.

### 1.2. Modification Examples of Laser Irradiation Apparatus

### 1.2.1. First Modification Example

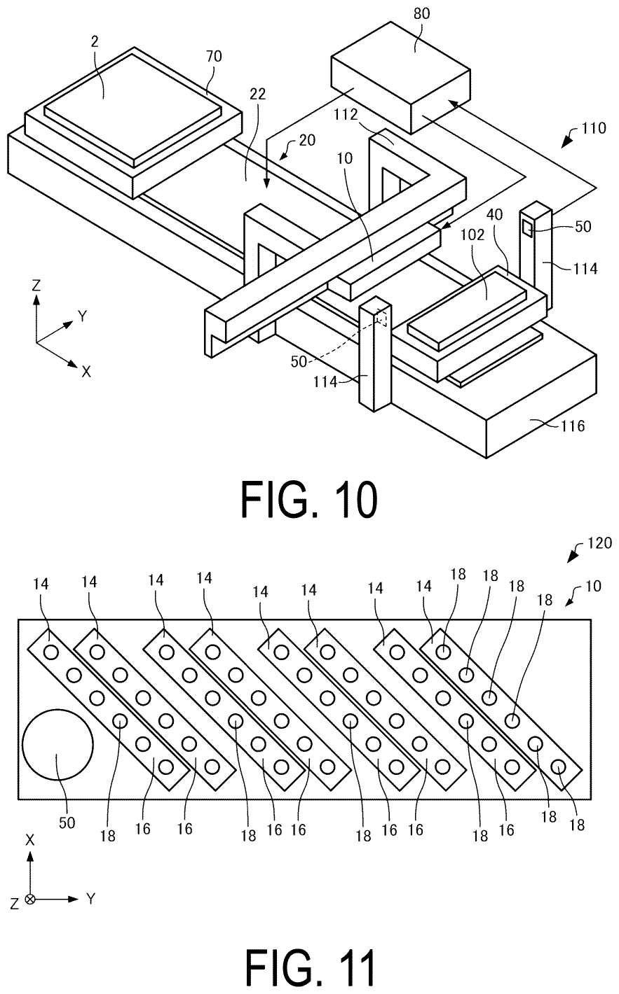

Next, a laser irradiation apparatus according to a first modification example of the first embodiment is described with reference to the drawings. FIG. 10 is a cross-sectional view schematically illustrating a laser irradiation apparatus 110 according to the first modification example of the first embodiment.

Hereinafter, in the laser irradiation apparatus 110 according to the first modification example of the first embodiment, members thereof having similar functions to the constituent members of the laser irradiation apparatus 100 according to the first embodiment described above are denoted with the same reference symbols, and the detailed description thereof is omitted. The same applies to a laser irradiation apparatus according to a second modification example of the first embodiment, which is described later.

In the laser irradiation apparatus 100 described above, as illustrated in FIG. 1, the head 10 is moved along the +X-axis direction in the processing process.

In contrast, as illustrated in FIG. 10, in the laser irradiation apparatus 110, the head 10 is fixed to a first fixing unit 112. For example, the laser irradiation apparatus 110 includes the first fixing unit 112, a second fixing unit 114, and a base table 116.

The first fixing unit 112 is provided across the rail 22 of the movement mechanism 20. In the processing process, the head 10 does not move. The head 10 is separated from the movement mechanism 20, and is positioned above the movement mechanism 20.

The second fixing unit 114 fixes the imaging unit 50. In the example illustrated in the drawing, two second fixing units 114 are provided. Two imaging units 50 are provided. As viewed in the Z-axis direction, the inspection target object 102 is provided between the two imaging units 50.

The base table 116 supports the rail 22. The rail 22 is provided on the base table 116. In the laser irradiation apparatus 110, the first support unit 40 and the second support unit 70 are provided on the rail 22. In the processing process, the control unit 80 controls the movement mechanism 20 to move the second support unit 70 along the +X-axis direction. As the second support unit 70 moves, the irradiation target object 2 moves along the +X-axis direction. In this manner, the relative position of the laser element 18 and the irradiation target object 2 is changed.

### 1.2.2. Second Modification Example

Next, the laser irradiation apparatus according to the second modification example of the first embodiment is described with reference to the drawings. FIG. 11 is a bottom view schematically illustrating the head 10 of a laser irradiation apparatus 120 according to the second modification example of the first embodiment.

In the laser irradiation apparatus 100 described above, as illustrated in FIG. 1, the imaging unit 50 is supported on the rail 22 of the movement mechanism 20.

In contrast, as illustrated in FIG. 11, in the laser irradiation apparatus 120, the imaging unit 50 is supported on the head 10. In the example illustrated in the drawing, the laser element array 14 has a shape extending in a direction inclined with respect to the X axis and the Y axis. A plurality of the laser element arrays 14 are provided. In the example illustrated in the drawing, eight of them are provided. The plurality of laser element arrays 14 are arrayed in the Y-axis direction. The imaging unit 50 is provided in the −Y-axis direction with respect to the lines of the plurality of laser element arrays 14.

### 2. Second Embodiment

### 2.1. Laser Irradiation Apparatus

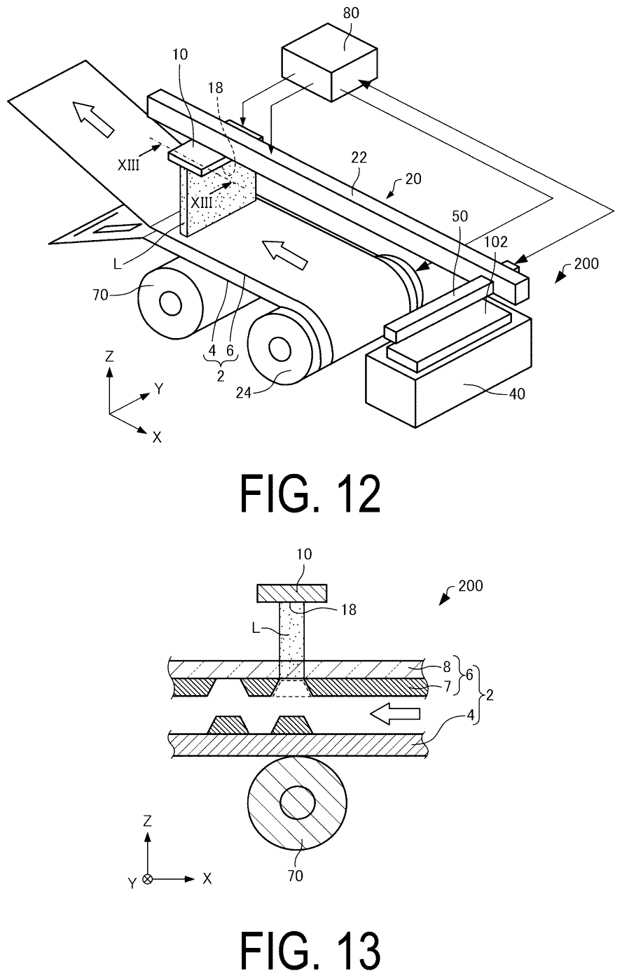

Next, a laser irradiation apparatus according to a second embodiment is described with reference to the drawings. FIG. 12 is a perspective view schematically illustrating a laser irradiation apparatus 200 according to the second embodiment. FIG. 13 is a cross-sectional view taken along the line XIII-XIII of FIG. 12 schematically illustrating the laser irradiation apparatus 200 according to the second embodiment.

Hereinafter, in the laser irradiation apparatus 200 according to the second embodiment, members thereof having similar functions to the constituent members of the laser irradiation apparatus 100 according to the first embodiment described above are denoted with the same reference symbols, and the detailed description thereof is omitted.

In the laser irradiation apparatus 100 described above, as illustrated in FIG. 1 and FIG. 2, the irradiation target object 2 is a process target object to be processed with the laser light L from the laser element 18.

In contrast, As illustrated in FIG. 12 and FIG. 13, in the laser irradiation apparatus 200, the irradiation target object 2 is a recording target object on which recording is performed with the laser light L from the laser element 18. The laser irradiation apparatus 200 is a recording apparatus.

For example, in the laser irradiation apparatus 200, the movement mechanism 20 includes a transport unit 24. The transport unit 24 transports the irradiation target object 2 to the second support unit 70 in a recording process for the irradiation target object 2. In the example illustrated in the drawing, the transport unit 24 transports the irradiation target object 2 in the −X-axis direction. For example, in the recording process, the head 10 is fixed. The irradiation target object 2 is wound about the transport unit 24. For example, the transport unit 24 is a roller that supplies the irradiation target object 2 to the second support unit 70. For example, the shape of the irradiation target object 2 is a sheet-like shape. For example, rotation of the transport unit 24 is controlled by the control unit 80.

For example, the second support unit 70 is provided in the −X-axis direction with respect to the transport unit 24. When recording is performed on the irradiation target object 2, the second support unit 70 supports the irradiation target object 2 transported from the transport unit 24. For example, the second support unit 70 is a platen roller. In the example illustrated in the drawing, the transport unit 24 and the second support unit 70 rotate about the Y axis. When the transport unit 24 and the second support unit 70 rotate, the movement mechanism 20 moves the irradiation target object 2 along the −X-axis direction.

In the recording process for the irradiation target object 2, the irradiation target object 2 is positioned between the head 10 and the second support unit 70. For example, the irradiation target object 2 includes a recording sheet 4 and an ink ribbon 6 provided above the recording sheet 4. As illustrated in FIG. 13, for example, the ink ribbon 6 includes an ink layer 7 formed of thermo-meltable ink and a base 8 provided on the ink layer 7. For example, the base 8 is transparent. At the time of irradiation with the laser light L from the head 10, the ink layer 7 in the irradiated part is melted and transferred onto the recording sheet 4. In this manner, recording such as printing can be performed on the recording sheet 4. For example, the laser irradiation apparatus 200 is a thermal printer of a thermal transfer type. Note that, for the sake of convenience of the description, in FIG. 13, the recording sheet 4 and the ink ribbon 6 are away from each other. In general, the recording sheet 4 and the ink ribbon 6 contact with each other.

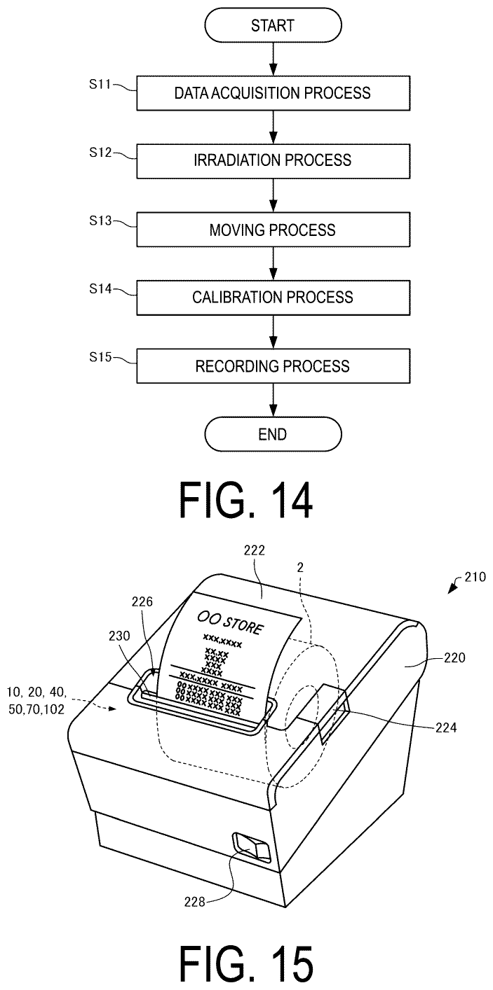

Herein, FIG. 14 is a flowchart for describing a process of the control unit 80 of the laser irradiation apparatus 200. For example, a user operates an operation unit, which is omitted in illustration, to output a process start signal for starting a process to the control unit 80. When the control unit 80 receives the process start signal, it starts the process.

First, as illustrated in FIG. 14, the control unit 80 executes a data acquisition process of acquiring printing data generated by a user (Step S11).

Subsequently, the control unit 80 executes an irradiation process (Step S12). The irradiation process is basically the same as the irradiation process of the laser irradiation apparatus 100 described above.

Subsequently, the control unit 80 executes a moving process (Step S13). The moving process is basically the same as the moving process of the laser irradiation apparatus 100 described above.

Subsequently, the control unit 80 executes a calibration process (Step S14). The calibration process is basically the same as the calibration process of the laser irradiation apparatus 100 described above.

Subsequently, the control unit 80 executes the processing process of controlling the laser element 18 and the movement mechanism 20 to irradiate the irradiation target object 2 with the laser light L, based on the imaging result in the calibration process in Step S14 while the laser element 18 and the irradiation target object 2 face each other, and at the same time to change the relative position of the laser element 18 and the irradiation target object 2 (Step S5).

Specifically, the control unit 80 causes the laser element 18 to emit the laser light L, based on the imaging result of the imaging unit 50 and the shaping data, while the laser element 18 and the irradiation target object 2 face each other. At the same time, the control unit 80 drives the transport unit 24 of the movement mechanism 20 to move the irradiation target object 2 along the −X-axis direction. In this manner, recording can be formed on the irradiation target object 2.

Further, the control unit 80 terminates the process.

In the laser irradiation apparatus 200, the irradiation target object 2 is a recording target object on which recording is performed with the laser light L from the laser element 18. Thus, in the laser irradiation apparatus 200, recording can be performed accurately on the irradiation target object 2.

### 2.2. Modification Example of Laser Irradiation Apparatus

Next, a laser irradiation apparatus according to a modification example of the second embodiment is described with reference to the drawings. FIG. 15 is a perspective view schematically illustrating a laser irradiation apparatus 210 according to the modification example of the second embodiment.

Hereinafter, in the laser irradiation apparatus 210 according to the modification example of the second embodiment, members thereof having similar functions to the constituent members of the laser irradiation apparatus 200 according to the second embodiment described above are denoted with the same reference symbols, and the detailed description thereof is omitted.

The laser irradiation apparatus 210 is a receipt printer, which is different from the laser irradiation apparatus 200 described above. For example, the laser irradiation apparatus 210 is provided to a register counter at a store such as a supermarket, a convenience store, and a restaurant. Further, the laser irradiation apparatus 210 issues a receipt as a result of printing an image on the irradiation target object 2 according to a transaction conducted at the register counter. For example, the material of the irradiation target object 2 is paper. Note that the material of the irradiation target object 2 may be polyethylene (PE), polyethylene terephthalate (PET), or polypropylene (PP).

As illustrated in FIG. 15, for example, the laser irradiation apparatus 210 includes an accommodation unit 220 and a cutter 230.

The accommodation unit 220 accommodates the irradiation target object 2 wound in a roll-like shape, the inspection target object 102, the head 10, the movement mechanism 20, the first support unit 40, the imaging unit 50, the second support unit 70, and the cutter 230. The accommodation unit 220 includes an openable/closable cover 222. When a user presses down a lever 224, the cover 222 is in an open state. A user can replenish or replace the irradiation target object 2 wound in a roll-like shape while the cover 222 opens. In the cover 222, a discharge slot 226 through which the irradiation target object 2 after printing is discharged is provided. Further, the accommodation unit 220 is provided with a power switch 228 for switching the power of the laser irradiation apparatus 210 between an on state and an off state.

The cutter 230 is provided at a position corresponding to the discharge slot 226. The cutter 230 cuts the irradiation target object 2 on which printing is performed. In this manner, a receipt is generated. The shape of the cutter 230 is not particularly limited as long as it can cut the irradiation target object 2.

Note that the applications of the laser irradiation apparatus according to the present disclosure are not particularly limited, and may include, for example, a laser cleaner for removing rust and the like from metal using laser light or a laser annealing apparatus for heating a surface of metal or a resin with laser light.

Further, the material of the irradiation target object is not particularly limited, and may be, for example, a resin such as a photo-curable resin, a wood material, glass, paper, leather, minerals, and the like.

The embodiments and the modification examples described above are merely examples, and are not intended as limiting. For example, each embodiment and each modification example can also be combined together as appropriate.

The present disclosure includes configurations that are substantially identical to the configurations described in the embodiments, for example, configurations with identical functions, methods and results, or with identical advantages and effects. Also, the present disclosure includes configurations obtained by replacing non-essential portions of the configurations described in the embodiments. In addition, the present disclosure also includes configurations that achieve the same effects as the configurations described in the embodiments or configurations that can achieve the same advantages. Further, the present disclosure includes configurations obtained by adding known techniques to the configurations described in the embodiments.

The following contents are derived from the embodiments and the modification examples described above.

A laser irradiation apparatus according to one aspect includes a laser element configured to emit laser light, a moving mechanism configured to move a relative position of the laser element and an irradiation target object and a relative position of the laser element and an inspection target object, an imaging unit configured to image the inspection target object, and a control unit configured to control the laser element, the moving mechanism, and the imaging unit, wherein the control unit executes: a first process of controlling the laser element and the moving mechanism to irradiate the inspection target object with laser light while the laser element and the inspection target object face each other, a second process of controlling the imaging unit to image the inspection target object being irradiated with the laser light, and a third process of controlling the laser element and the moving mechanism to irradiate the irradiation target object with laser light, based on an imaging result in the second process, while the laser element and the irradiation target object face each other, and at the same time to change the relative position of the laser element and the irradiation target object.

According to the laser irradiation apparatus, the irradiation target object can be irradiated accurately.

In the laser irradiation apparatus according to the one aspect, the laser element and the imaging unit may be supported on the moving mechanism.

According to the laser irradiation apparatus, the apparatus can be simplified.

The laser irradiation apparatus according to the one aspect may include a first support unit configured to support the inspection target object, and a second support unit configured to support the irradiation target object, wherein the moving mechanism may move the laser element along a first direction, and the first support unit and the second support unit may be arrayed in the first direction.

According to the laser irradiation apparatus, the apparatus can be simplified.

In the laser irradiation apparatus according to the one aspect, materials of the irradiation target object and the inspection target object may be the same.

According to the laser irradiation apparatus, for example, a difference in a linewidth of the laser light between the first process and the third process can be reduced.

In the laser irradiation apparatus according to the one aspect, the irradiation target object may be a process target object to be processed with laser light from the laser element.

According to the laser irradiation apparatus, the irradiation target object can be processed accurately.

In the laser irradiation apparatus according to the one aspect, the irradiation target object may be a recording target object to be recorded with laser light from the laser element.

According to the laser irradiation apparatus, recording can be performed accurately on the irradiation target object.

In the laser irradiation apparatus according to the one aspect, the laser element may be a photonic crystal surface emitting laser.

According to the laser irradiation apparatus, a radiation angle of the laser light from the laser element can be narrowed.

What is claimed is:

1. A laser irradiation apparatus comprising:
a laser element configured to emit laser light;
a moving mechanism configured to move a relative position of the laser element and an irradiation target object and a relative position of the laser element and an inspection target object;
an imaging unit configured to image the inspection target object; and
a control unit configured to control the laser element, the moving mechanism, and the imaging unit, wherein
the control unit is configured to execute:
a first process in which the control unit controls the laser element and the moving mechanism to irradiate the inspection target object with laser light while the laser element and the inspection target object face each other;
a second process in which the control unit controls the imaging unit to image the inspection target object being irradiated with the laser light; and
a third process in which the control unit controls the laser element and the moving mechanism to irradiate the irradiation target object with laser light, based on an imaging result in the second process, while the laser element and the irradiation target object face each other, and at the same time to change the relative position of the laser element and the irradiation target object.

2. A laser irradiation apparatus according to claim 1, wherein
the laser element and the imaging unit are supported by the moving mechanism.

3. A laser irradiation apparatus according to claim 1, comprising:
a first support unit configured to support the inspection target object; and
a second support unit configured to support the irradiation target object, wherein
the moving mechanism is configured to move the laser element along a first direction, and
the first support unit and the second support unit are arrayed in the first direction.

4. A laser irradiation apparatus according to claim 1, wherein
materials of the irradiation target object and the inspection target object are the same.

5. A laser irradiation apparatus according to claim 1, wherein
the irradiation target object is a process target object to be processed with laser light from the laser element.

6. A laser irradiation apparatus according to claim 1, wherein
the irradiation target object is a recording target object to be recorded with laser light from the laser element.

7. A laser irradiation apparatus according to claim 1, wherein
the laser element is a photonic crystal surface emitting laser.
